(19) United States
(12) Patent Application Publication
(10) Pub. No.: US 2015/0195181 A1
(43) Pub. Date: Jul. 9, 2015

(54) TESTING OF DYNAMIC WEB CONTENT APPLICATIONS

(71) Applicant: Shishir Birmiwal, Santa Clara, CA (US)

(72) Inventor: Shishir Birmiwal, Santa Clara, CA (US)

(73) Assignee: GOOGLE INC., Mountain View, CA (US)

(21) Appl. No.: 12/894,760

(22) Filed: Sep. 30, 2010

(51) Int. Cl. H04L 12/26; H04L 29/08

(52) U.S. Cl. CPC H04L 43/50; H04L 67/10

(57) ABSTRACT

Methods, systems, and apparatus, including computer programs encoded on a computer storage medium, for repeatedly testing applications that request dynamic web content. In one aspect, systems for the repeated testing of a collection of applications that request dynamic web content include a collection of application testing clients each comprising one or more data processing devices, each client programmed to test applications that request dynamic web content by executing assigned applications and a server system. The server system includes one or more data storage devices storing information characterizing the collection of applications that request dynamic web content that are to be repeatedly tested, one or more data processing devices programmed to repeatedly assign the applications in the collection to respective of the application testing clients for testing, and one or more communications interfaces operable to exchange information with the application testing clients.

### BACKGROUND

This specification relates to digital data processing, and in particular to the testing of applications that request dynamic web content.

Dynamic web content is information that is dynamically generated for an application. Dynamic web content is generally generated on-the-fly in response to a request and hence delivered in a different format than stored on a web server. For example, dynamic web content can be a selected subset of a larger collection of stored information or dynamic web content can be the result of computations performed on such stored information. Dynamic web content can be generated using, e.g., Common Gateway Interface (CGI) compliant web server software. Dynamic web content can be tailored to, e.g., a profile of a particular recipient or the characteristics of a request. For example, dynamic web content can be used to deliver a personalized collection of stock quotes, weather forecasts for cities of interest, and scores from games involving a user's favorite teams.

Applications that request dynamic web content include gadgets. Gadgets are (generally miniature) applications that request dynamic web content and provide services to other applications using the dynamic web content. Gadgets can be games, news feeds, maps or other content or applications. In some instances, multiple gadgets can run in a single environment, e.g., a single web-page or a computer desktop. Gadgets can be implemented using, e.g., XML, JavaScript, HTML, or other languages.

The dynamic web content requested by gadgets, and the services provided by the gadgets using that content, can generally be tailored by a user. For example, a user may be able to specify the holdings within a personal stock portfolio or teams or cities of interest. These specifications can in turn be used to specify the format and/or substance of the dynamic web content that is delivered to the gadget.

In some circumstance, dynamic web content applications are developed by one entity and distributed by another. Either of these two entities, or one or more other entities, may maintain a web server that generates dynamic web content accessed by the gadget. The entity that distributes a gadget can do so, e.g., by providing links to a site that hosts the gadget, by hosting the gadget itself, or by otherwise making the gadget available to the public.

### SUMMARY

This specification describes technologies relating to repeated testing of applications that request dynamic web content, e.g., to ensure the quality and security of such applications. Dynamic web content applications are active components that necessarily retrieve data from a web server. Through incompetence, malicious intent, or otherwise, such retrieved content can in some circumstances be harmful or otherwise undesirable.

Pre-distribution testing of an application that requests dynamic web content may not be able to prevent such harm or other problems under all circumstances. For example, a malicious dynamic web content application can be designed to be harmful only some of the time or only under certain circumstances that are absent from the pre-distribution testing. As another example, errors in an application that request dynamic web content may accumulate and not be apparent during the necessarily finite pre-distribution testing. As another example, a server from which an application requests dynamic web content may simply become unavailable or even begin delivering malicious content, e.g., after pre-distribution testing has finished. As yet another example, a malicious application that requests dynamic web content may, apparently innocuously, collect personal data over an extended period of time and only transmit that personal data to an external party at a time that is after the pre-distribution testing.

In contrast, repeated testing addresses many of these deficiencies. For example, repeated testing can ensure that applications that that request dynamic web content are tested at a number of different times to ensure their continued integrity. The applications can be repeatedly tested before being made available and continuously while they are made available. Further, in some implementations, the tests themselves can be changed so that application integrity is checked under a variety of different circumstances. In some cases, a distributor may subject a library of applications that request dynamic web content to continuous, ongoing testing. The results of such testing can be used to both ensure the ongoing integrity of the library but also to prevent harm to users who have previously drawn applications from the library.

Accordingly, technologies for the repeated testing of applications that request dynamic web content are described. In one aspect, systems for the repeated testing of a collection of applications that request dynamic web content include a collection of application testing clients each comprising one or more data processing devices, each client programmed to test applications that request dynamic web content by executing assigned applications and a server system. The server system includes one or more data storage devices storing information characterizing the collection of applications that request dynamic web content that are to be repeatedly tested, one or more data processing devices programmed to repeatedly assign the applications in the collection to respective of the application testing clients for testing, and one or more communications interfaces operable to exchange information with the application testing clients.

This and other aspects can include one or more of the following features. Each client can be programmed to collect at least some of the content of one or more messages exchanged with the applications as a result of the execution. The application testing clients can be programmed to transmit the collected content to the server system. The server system can be programmed to record the transmitted content in the one or more data storage devices. The collected content can include a URL from which the dynamic web content was requested during the testing. The server system can be programmed to compare the URL from which the dynamic web content was requested with a list of problem URLs. The application testing clients each can be programmed to collect statistics regarding the messages exchanged as a result of the execution and to transmit the collected statistics to the to the server system. The server system can be programmed to record the transmitted statistics in the one or more data storage devices. The one or more data processing devices of the server system can be programmed to assign the applications to the respective of the application testing clients according to test-dependent factors that characterize the particular test to be performed by the respective of the application testing clients. The one or more data processing devices of the server system can be programmed to assign the applications to the respective of the application testing clients according to the testing routines used at the respective of the application testing clients. The one or more data processing devices of the server system can be programmed to assign the applications to the respective of the application testing clients according to the testing environment used at the respective of the application testing clients. The server system can be programmed to transmit an identifier of a first application in the collection to a first of the application testing clients in response to receipt of a confirmation received from the first application testing client that testing of a second application in the collection is completed. The system can include a security barrier that separates server system from application testing clients. The server system can also be programmed to interpret the collected content and to take remedial action in light of the interpretation of the collected content. The system can include a proxy programmed to disguise the Internet Protocol address of at least one of the application testing clients.

In another aspect, tangible computer storage media are encoded with computer programs. The programs include instructions that when executed by data processing apparatus cause data processing apparatus to perform operations. The operations include repeatedly testing a collection of applications that request dynamic web content. Repeatedly testing the applications includes distributing to each of a collection of application testing client data processing devices, an identity of an application that requests dynamic web content and that is to be tested by the recipient application testing client data processing device, receiving confirmations of starts and progress in the testing of the applications by the application testing client data processing devices, identifying, based on the confirmations of progress in the testing of the applications, a deficient rate of progress in the testing of a first of the applications performed by a first of the application testing client data processing devices, and halting, in response to the identification of the deficient rate of progress in the testing of the first application, the testing of the first application at the first application testing client data processing device.

This and other aspects can include one or more of the following features. Distributing the identities of the applications can include distributing the identities according to test-dependent factors that characterize the particular test to be performed by the recipient application testing client data processing device. The first application can be reassigned to a second of the application testing client data processing devices for testing in response to the identification of the deficient rate of progress in the testing of the first application. A restart message can be transmitted to the first application testing client data processing device in response to the identification of the deficient rate of progress in the testing of the first application.

In another aspect, methods implemented by a server system of one or more data processing devices include assigning a first application that requests dynamic web content to one of a collection of application testing client data processing devices for a first test, the first test beginning at a first time and lasting for a first test period, receiving and storing results of the first test, wherein the results of the first test include at least some statistics regarding requests for dynamic web content made by the first application during the first test period, assigning the same first application to one of the collection of application testing client data processing devices for a second test, the second test beginning at a second time and lasting for a second test period, and receiving and storing results of the second test, wherein the results of the second test include at least some statistics regarding requests for dynamic web content made by the second application during the second test period.

This and other aspects can include one or more of the following features. The application testing client data processing device that is assigned the first application for the first test can differ from the application testing client data processing device that is assigned the first application for the second test. The method can include the server system interpreting the results of the first test and the results of the second test and the server system taking remedial action in response to the interpretation of the results of one of the first and the second test.

The results of the first test can include at least some content of the requests for dynamic web content made by the first application during the first test period and at least some content of responses to the requests for dynamic web content made by the first application during the first test period. The results of the second test can include at least some content of the requests for dynamic web content made by the first application during the second test period and at least some content of responses to the requests for dynamic web content made by the first application during the second test period.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic representation of an example system for the repeated testing of applications that request dynamic web content.

FIG. 2 is a schematic representation of an example application testing client for the repeated testing of applications that request dynamic web content.

FIG. 3 is a schematic representation of an example execution checking component for the repeated testing of applications that request dynamic web content.

FIG. 4 is a schematic representation of an example collection of test results that can be returned from application testing clients to a server system.

FIG. 5 is a flowchart of an example process for the repeated testing of applications that request dynamic web content.

FIG. 6 is a schematic representation of an example display of information provided by a system for the repeated testing of applications that request dynamic web content.

FIG. 7 is a flowchart of an example process for the repeated testing of applications that request dynamic web content.

Like reference numbers and designations in the various drawings indicate like elements.

### DETAILED DESCRIPTION

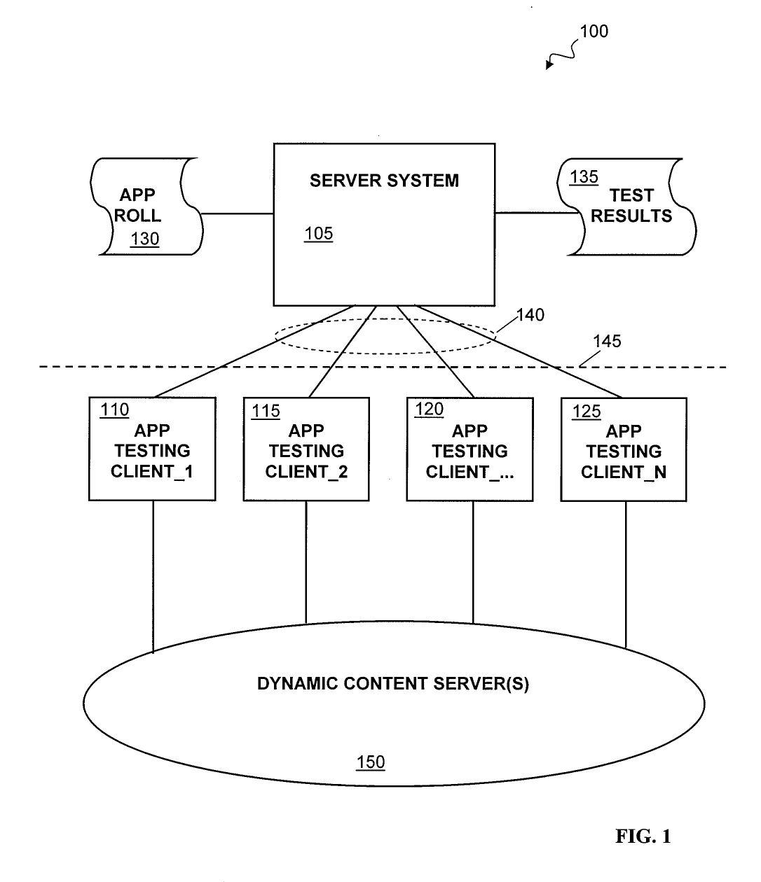

FIG. 1 is a schematic representation of an example system 100 for the repeated testing of applications that request dynamic web content. System 100 includes a server system 105, a collection of application testing clients 110, 115, 120, 125, a roll 130 of applications to be repeatedly tested, and a log 135 of test results. In system 100, clients 110, 115, 120, 125 repeatedly test applications that request dynamic web content to ensure the quality and security of the data processing activities performed by those applications under the direction of server system 105. The results of the repeated testing are collected and can be used, e.g., improve the quality of any deficient applications and prevent harm due to the deficient applications.

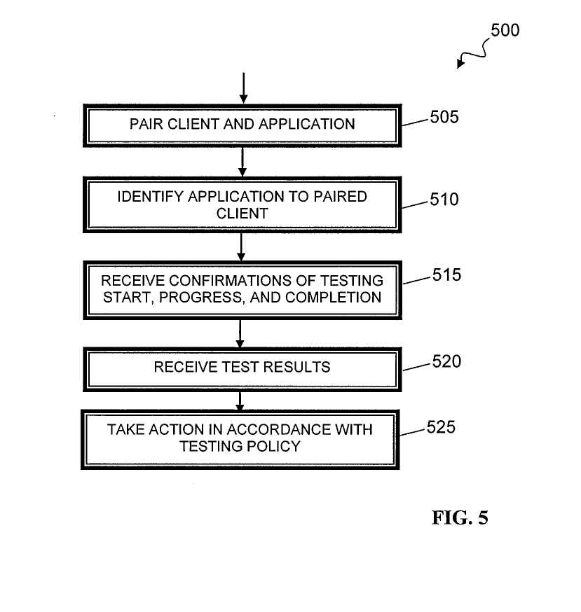

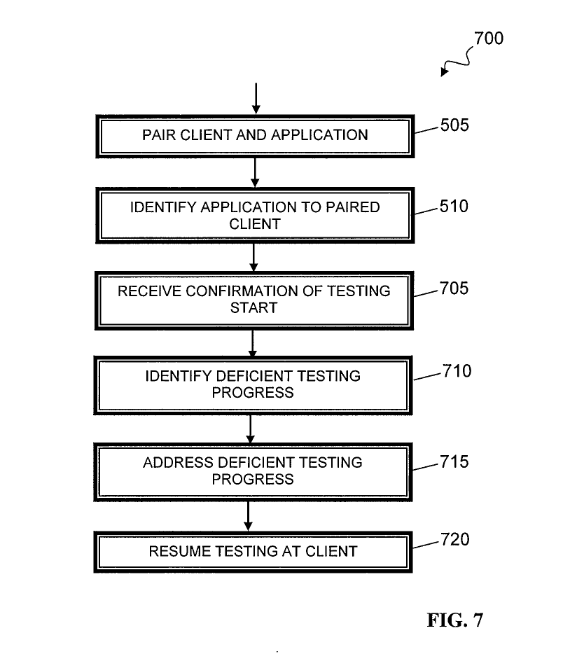

Server system 105 is a system of one or more data processing devices that perform operations in accordance with the logic of one or more sets of machine-readable instructions. The instructions can be tangibly embodied in hardware, in software, or in combinations thereof. The activities performed by server can include directing the repeated testing of applications by clients 110, 115, 120, 125 and collecting the results of that repeated testing. In some implementations, server system 105 can also perform prophylactic or other activities to improve quality and prevent harm. Examples of activities that can be performed by server system 105 are described, e.g., in FIGS. 5 and 7.

Server system 105 includes a communications interface connected for data communication with each of application testing clients 110, 115, 120, 125 via one or more data links 140. Data links 140 allow server system 105 to exchange information with application testing clients 110, 115, 120, 125. The exchanged information can include, e.g., the identities of applications to be tested and the results of the testing.

Despite the data exchange afforded by data links 140, system 100 can in some implementations include a security barrier 145 that separates server system 105 from application testing clients 110, 115, 120, 125. Security barrier 145 is a security mechanism that is designed to prevent malicious attacks or other malfunctions from propagating from application testing clients 110, 115, 120, 125 to server system 105. Security barrier 145 can be implemented in a number of different ways. For example, in some implementations, security barrier 145 can be implemented as a firewall that monitors traffic on data links 140. For example, such a firewall can allow only predefined types of messages between server system 105 from application testing clients 110, 115, 120, 125 while excluding others. As another example, security barrier 145 can be implemented as hashing or other component on server system 105 for reviewing incoming messages and ensuring that they are appropriate. As another example, security barrier 145 can be implemented by running application testing clients 110, 115, 120, 125 in a virtual machine or on a different network. In some implementations, application testing clients 110, 115, 120, 125 can be repeatedly sanitized (e.g., reformatted, reimaged, and/or reinstalled) to prevent malicious attacks or other malfunctions from propagating from application testing clients 110, 115, 120, 125 to server system 105. Thus, although security barrier 145 is schematically represented as positioned across data links 140, security barrier 145 can also be implemented at other locations in system 100 or not at all.

Each application testing client 110, 115, 120, 125 is a system of one or more data processing devices that perform operations in accordance with the logic of one or more sets of machine-readable instructions. These instructions include the applications under test. The instructions can be tangibly embodied in hardware, in software, or in combinations thereof. The activities performed by application testing client 110, 115, 120, 125 can include the retrieval of the applications under test, inspection of the content of the applications under test, inspection and recording of the messages sent to and received by the applications under test, and the preparation of logs of test results.

In some implementations, at least some of the application testing clients 110, 115, 120, 125 can have characteristics that differ from one another in ways that impact the testing of the applications under test. For example, different application testing clients 110, 115, 120, 125 can run the applications under test in different environments (e.g., in different web browsers or different desktops), execute different testing routines (e.g., with different test conditions), and/or use different proxies during the test, as described further below.

Application roll 130 is a collection of identifiers of applications that are to be repeatedly tested by system 100. Applications can be identified in application roll 130, e.g., by name, by Uniform Resource Identifier (URI), or by other identifier. Application roll 130 can be persistently stored in a system of one or more data storage devices and can be implemented as an ordered array of items (e.g., a list), as a hierarchical array, or in other data storage structures. In general, application roll 130 dynamically changes, e.g., as new applications are added and old applications are removed. In some implementations, server system 105 itself can remove applications from application roll 130, e.g., in response to a test result received from one of application testing clients 110, 115, 120, 125.

Test result log 135 is a collection of data that characterizes the results of the repeated testing of applications that request dynamic web content. Test result log 135 generally increases in size as applications are repeatedly tested. Test result log 135 can be persistently stored in a system of one or more data storage devices and can be implemented, e.g., as a linked list of records of test results, as a hierarchical array, or in other data storage structures. In some implementations, test result log 135 is stored in the same data storage device system that stores application roll 130. For example, application roll 130 and test result log 135 can be integrated into a single data storage structure. In some implementations, test result log 135 can also include the results of remedial action that has been taken to address an deficiencies, as described further below.

In operation, server system 105 can repeatedly traverse application roll 130 to retrieve the identifiers of applications to be tested. Server system 105 can distribute the identifiers to application testing clients 110, 115, 120, 125, assigning respective application testing clients 110, 115, 120, 125 to test the identified application. Server system 105 can distribute the identifiers to application testing clients 110, 115, 120, 125 according to, e.g., the availability of each application testing client 110, 115, 120, 125 to perform the test, the time since the application was last tested, the different test characteristics of the application testing clients 110, 115, 120, 125, and other factors as described further below.

In response to receipt of an identifier, application testing clients 110, 115, 120, 125 can access and execute the identified application. The identified application can be executed in accordance with one or more test routines that are designed to result in requests for dynamic web content to one or more dynamic content servers. Application testing clients 110, 115, 120, 125 transmit the requests to the same dynamic content servers 150 that would receive the requests during normal operation of the applications that request dynamic web content, i.e., during execution of the applications that request dynamic web content on machines outside system 100. As described further below, in some implementations, the requests can be transmitted over a proxy that disguises the Internet Protocol (IP) address of the application testing client 110, 115, 120, 125 in an attempt to ensure that testing by system 100 is indistinguishable from normal operation of the applications that request dynamic web content.

Application testing clients 110, 115, 120, 125 inspect the dynamic web content requests and responses in an attempt to identify harmful or otherwise undesirable messages. In some implementations, application testing clients 110, 115, 120, 125 can also record all or a portion of these communications for subsequent review. Application testing clients 110, 115, 120, 125 transmit the results of the inspections (with or without any recorded portion, as the case may be) to server system 105 for recording in test result log 135.

In some implementations, server system 105 responds to the receipt of inspection results with an identifier of another application that is to be tested. In other implementations, server system 105 distributes such identifiers independently of the receipt of inspection results. For example, a queue of identifiers of applications to be tested can be built up at each application testing client 110, 115, 120, 125 by server system 105. In any case, after completing the testing of one application that requests dynamic content, application testing clients 110, 115, 120, 125 test a different such application.

In some implementations, server system 105 merely records the test results in test result log 135 as it repeatedly traverses application roll 130. The test results in result log 135 can be made available for review to determine whether any of the applications under test are deficient and/or remedial action is needed. Examples of remedial actions include one or more of the following:
identifying deficiencies in the operation of applications that request dynamic web content to the developers of those applications by, e.g., electronic mail or otherwise;
ending distribution of deficient applications to the public;
checking other application for malicious content found in one application;
blacklisting malicious applications and/or developers of malicious applications so that the blacklisted applications, and/or other applications developed by the blacklisted developers, are no longer distributed by the entity that operates system 100; and
informing users who have installed a deficient application of the application deficiencies.
   In some implementations, the review and remedial acts are performed by another system of one or more data processing devices. In other implementations, server system 105 itself can perform the review and undertake any remedial action. The review and remedial action can also be performed manually by human users. In some implementations, the results of remedial action can be stored in test result log 135.

In some implementations, server system 105 can also be responsible for checking the function of individual application testing client 110, 115, 120, 125 or for checking the function of system 100 as a whole. Such checks can be performed on start or intermittently. System-wide deficiencies and deficiencies in individual application testing client 110, 115, 120, 125 can be identified, e.g., by comparing the results of testing known applications with expected results. A mismatch can be indicative of a deficiency. If deficiency are found during such intermittent checks, then the testing of applications by application testing clients 110, 115, 120, 125 can be halted and the cause of any deficiency determined. If the system deficiency is attributable to a particular application under test, then appropriate remedial actions can be taken.

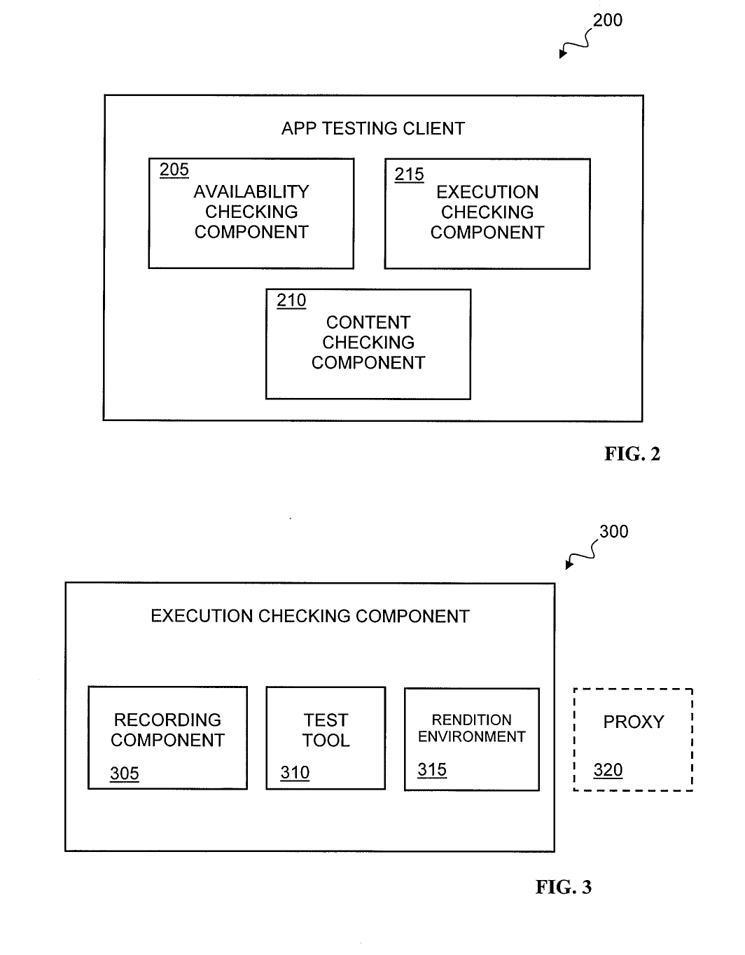

FIG. 2 is a schematic representation of an application testing client 200 for the repeated testing of applications that request dynamic web content. Application testing client 200 can serve as one or more of application testing clients 110, 115, 120, 125 in system 100 (FIG. 1). Application testing client 200 includes an availability checking component 205, a content checking component 210, and an execution checking component 210. Components 205, 210, 215 are hardware or software elements that perform particular operations within application testing client 200. The results of those operations can be combined into a collection of test results that can be stored, e.g., in result log 135 (FIG. 1).

Availability checking component 205 checks whether an application that requests dynamic web content is indeed available. As described above, dynamic web content applications can be developed by one entity and distributed by another. Availability checking component 205 can be used by the distributing entity to determine whether such an application is indeed available from the developer. For example, the distributing entity can check whether the application is available on the site indicated by the developer, whether an available application meets completeness and other formal requirements, and/or whether identifiers of the application that are to be used in distributing the application (e.g., an application name or a thumbnail or other likeness that represents the application) are available.

Content checking component 210 checks the content of an application that requests dynamic web content. The content check can include a scan for viruses or other malicious content, a scan for content that infringes trademarks, a scan for content that infringes copyrights, and/or a scan for pornography or other undesirable content.

Execution checking component 210 checks the execution of an application that requests dynamic web content. The execution can be checked by executing the application that requests dynamic web content in a test environment under a test set of conditions and recording the results of that execution. In some implementations, the test environment and conditions can be changed so that applications under test can be tested under diverse conditions. Such diverse tests can be performed, e.g., by a single execution checking component 210 with a variable test environment and/or conditions, or by a collection of different execution checking components 210 (e.g., application testing clients 110, 115, 120, 125 (FIG. 1)) with static or variable test environments and/or conditions.

FIG. 3 is a schematic representation of an execution checking component 300 for the repeated testing of applications that request dynamic web content. Execution checking component 300 can serve as execution checking component 210 (FIG. 2) in one or more of application testing clients 110, 115, 120, 125 in system 100 (FIG. 1).

Execution checking component 300 includes a recording component 305, a test tool component 310, and a rendition environment component 315. Components 305, 310, 315 are hardware or software elements that perform particular operations within execution checking component 300.

Recording component 305 records aspects of the execution of an application that requests dynamic web content. The recorded aspects can include, e.g., the content and destination of outgoing messages (including service requests), the content and source of incoming messages (including service responses), and/or trace information. In some implementations, particular events in the execution of an application can be recorded. For example, recording component 305 can record http errors, redirects of service requests, and/or any pop-up windows that result from the execution of an application that requests dynamic web content.

Test tool component 310 is a component that generates a test set of conditions for the executing application. The test conditions generally emulate input and/or other personalization made by a user to an application that requests dynamic web content. For example, test tool component 310 may generate a test set of conditions emulating the personalization of an application to a particular stock portfolio or location of interest.

Rendition environment component 315 provides the environment in which the application under test executes. Rendition environment component 315 can reflect the different environments in which different applications that request dynamic web content operate. For example, in testing applications that request dynamic web content in a browser, rendition environment component 315 can be a browser. As another example, in testing applications that request dynamic web content in a computer desktop, rendition environment component 315 can be a computer desktop.

The test execution environment and conditions can be changed so that applications under test can be tested under diverse conditions. Such diverse tests can be performed, e.g., by a single execution checking component 230 with a variety of different test tools 310 and/or rendition environments 315, or by a collection of different execution checking components 300 with multiple test tools 310 and/or rendition environments 315.

In some implementations, execution checking component 230 can operate in conjunction with a proxy 320. Proxy 320 is a system of one or more data processing devices that perform operations in accordance with the logic of one or more sets of machine-readable instructions. The instructions can be tangibly embodied in hardware, in software, or in combinations thereof. Proxy 320 accepts requests for dynamic web content generated by the application under test, disguises the Internet Protocol (IP) address identifying the source of the request, and relays the disguised request to a server of the dynamic web content. These activities attempt to make the testing performed by execution checking component 230 indistinguishable from normal operation of the application under test. Proxy 320 can be external to execution checking component 230 (as shown) or proxy 320 can be integrated into execution checking component 230.

In some implementations, all or a portion of execution checking component 230 can be implemented using the SELENIUM REMOTE CONTROL test tool, originally developed by THOUGHTWORKS INC. Chicago, Ill. SELENIUM REMOTE CONTROL can launch browser sessions (which act as rendition environment 315) and run tests in those sessions (acting as test tool 310).

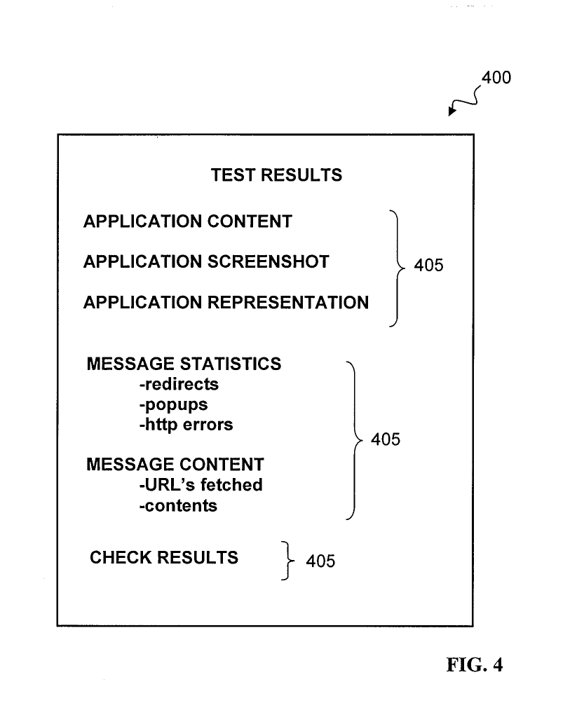

FIG. 4 is a schematic representation of a collection 400 of test results that can be returned from application testing clients to, e.g., a server system 105 in system 100 (FIG. 1). Collection 400 can be organized into one or more record, files, or other structures and stored, after receipt by server system 105, at test result log 135.

Test result collection 400 includes a collection of information 405 characterizing the application itself, a collection of information 410 characterizing the execution of the application, and a collection of information 415 characterizing the results of various other checks made on the application.

For example, in the illustrated implementation, application—characterizing information collection 405 includes information characterizing the content of the application (e.g., XML, JavaScript, HTML, or other instructions that form the application), a screenshot of the application in operation, and a graphical representation of the application, such as a thumbnail image or other likeness. Execution—characterizing information 410 includes information characterizing various message statistics (e.g., request redirects, popups, and http errors) and the content of those messages (e.g., the content of outgoing messages, the URL's from which dynamic content is requested, and the content of incoming messages (including the requested dynamic content). Check—characterizing information 415 includes, e.g., information characterizing the results of various checks performed on the application. The checks can include checks of metadata characterizing the application that are not necessary for operation of the application but rather are required from developers by the entity that distributes the application. Examples of such metadata includes developer contact information, valid author name/email, valid thumbnail/screenshot, valid XML description of the gadget, and a check for uniqueness (content, name, etc).

FIG. 5 is a flowchart of a process 500 for the repeated testing of applications that request dynamic web content. Process 500 can be performed by a system of one or more data processing devices that perform operations in accordance with the logic of one or more sets of machine-readable instructions. The instructions can be tangibly embodied in hardware, in software, or in combinations thereof. For example, process 500 can be performed by server system 105 in system 100 (FIG. 1). Process 500 can be performed alone or in conjunction with other activities. For example, process 500 can be performed in conjunction with process 700 (FIG. 7), as described further below.

The system performing process 500 pairs an application that requests dynamic web content with a client that is to perform a test on that application at 505. For example, in the context of system 100 (FIG. 1), the system performing process 500 can select at least one of application testing clients 110, 115, 120, 125 to test an application.

The pairing of an application with a client can consider one or more different factors. The factors can include test-independent factors and test-dependent factors. Test-independent factors are factors that are independent of the characteristics of the test that is to be performed. Examples of test-independent factors include the availability of the client and the time since the application was last tested. For example, the system performing process 500 can implement a FIFO application queue and assign the first application in the queue to the first client that becomes available, e.g., after that client completes testing of another application. As another example, the system performing process 500 can pair applications with clients according to a round-robin or other selection scheme.

Test-dependent factors are factors that characterize the particular test to be performed). Examples of test-dependent factors include the testing environment used at the client (e.g., the web browsers or desktops provided at the client) and the testing routines used at the client (e.g., the test conditions provided at the client). For example, the system performing process 500 can implement a collection of FIFO application queues, each of which is associated with one or more application testing clients 110, 115, 120, 125 having related or identical test-dependent factors. In response to a first of the application testing client 110, 115, 120, 125 completing testing of a first application, the first application can be added to a queue that is associated with one or more different application testing clients 110, 115, 120, 125 having different test-dependent factors than the first application testing client 110, 115, 120, 125. In this way, repeated testing in a diverse set of environments under a diverse set of conditions can proceed.

The system performing process 500 identifies the application that requests dynamic web content to the paired client at 510. The application can be identified by a name, a site, a URI or by other identifier that is transmitted to the paired client. In some implementations, the application is identified to the paired client in response to receipt of a notification from the client that the client is available to perform the test. In other implementations, the application is identified to a paired client that maintains a local queue of applications to be tested.

The system performing process 500 receives confirmations of the start of testing of the paired application, the progress of testing of the paired application, and the completion of testing of the paired application at 515. As described further below, these confirmations can provide information to the system performing process 500 that facilitate management of the testing process.

The system performing process 500 receives the results of testing the paired application at 520. In some implementations, the results can be recorded in a test result collection such as, e.g., collection 400 (FIG. 4). The system performing process 500 also takes action in accordance with the testing policy at 525. The testing policy can specify, e.g., the nature and extent of any result interpretation and remedial actions performed by the system performing process 500. For example, the system can record the received test results, e.g., in test result log 135 (FIG. 1) and consider the completion of the test in subsequent pairings of that client with other applications. In some implementations, the system performing process 500 can also interpret the results and take one or more remedial actions in light of that interpretation of the results. Result interpretation can include, e.g., scanning the content of the application that requests dynamic web content or the messages exchanged with the application for viruses or other malicious content, scanning the content of outgoing messages for personal information that was not intentionally released, comparing the URL's from which content was requested and received with the URL's of known problem URL's, and the like. Examples of remedial actions include one or more of the following:
identifying deficiencies in the operation of applications that request dynamic web content to the developers of those applications by, e.g., electronic mail or otherwise;
ending distribution of deficient applications to the public;
checking other application for malicious content found in one application;
blacklisting malicious applications and/or developers of malicious applications so that the blacklisted applications, and/or other applications developed by the blacklisted developers, are no longer distributed by the entity that operates the system performing process 500; and
informing users who have installed a deficient application of the application deficiencies.

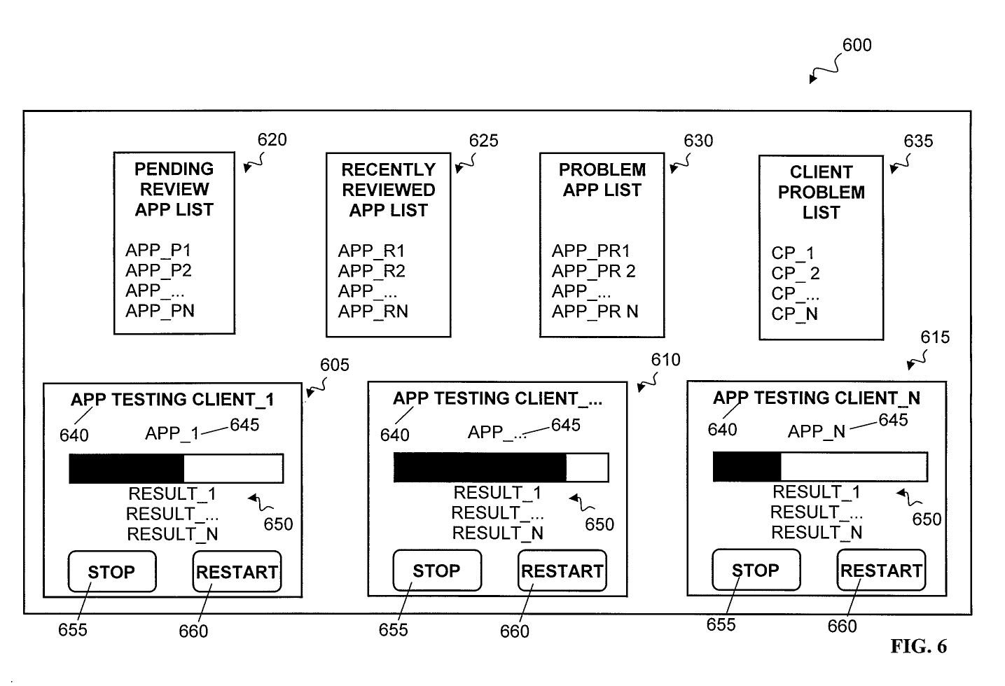

FIG. 6 is a schematic representation of an example display of information 600 provided by a system for the repeated testing of applications that request dynamic web content. Graphical information 600 can be provided by a server system 105 that manages the repeated testing of applications that request dynamic web content by a collection of clients, e.g., in a single screenshot or in a collection of multiple display screens. For example, in the context of system 100, graphical information 600 can be provided by server system 105 using information drawn from application roll 130, test result log 135, and confirmations of testing start, progress, and completion received from application testing clients 110, 115, 120, 125 (FIG. 1).

Graphical information 600 includes a collection of progress reports 605, 610, 615 characterizing the progress of current testing of individual applications at application testing clients 110, 115, 120, 125 and a collection of a progress reports 620, 625, 630, 635 characterizing the progress of testing a collection of applications. In particular, progress report 605 characterizes the current testing of a first application by a first client, progress report 610 characterizes the current testing of a second application by a second client, and progress report 615 characterizes the current testing of a third application by a third client. Each progress report 605, 610, 615 includes a identifier 640 of the client performing the testing, an identifier 645 of the paired application being testing, and information 650 characterizing the progress of that testing. In the illustrated implementation, identifiers 640, 645 are textual names of the client and its paired application and are associated with one another by virtue of their disposition and arrangement in progress reports 605, 610, 615 on display 600.

In the illustrated implementation, progress—characterizing information 650 includes a bar-shaped or other display element that represents the rate of progress in the testing. The rate of progress presented in progress—characterizing information 650 can be determined, e.g., from confirmations of progress in the testing of the paired applications that are received during testing (e.g. at 515 in process 500 (FIG. 5)). By presenting the amount of progress per unit time to a user, progress—characterizing information 650 allows a user to monitor progress and possibly detect any derailment of the testing, e.g., due to malicious or other deficiencies in the application being tested. In particular, a user can recognize that execution of an application that requests dynamic web content during testing has been derailed. The recognition of such a derailment can be addressed, e.g., by stopping testing of that application using, e.g., an interactive graphical element such as widget 655 or by restarting testing of that application using, e.g., an interactive graphical element such as widget 660. In some implementations, progress—characterizing information 650 can also include graphical or other display element that represents the absolute progress in the testing (e.g., 50% complete, 60% complete, etc.), as well as textual characterization of testing results (as shown).

Progress report 620 includes information characterizing the applications that request dynamic web content for which review is pending. Progress report 620 can identify those applications by name or other identifier. In some implementations, the applications for which review is pending can be listed in progress report 620 in the order in which they are currently scheduled to be reviewed.

Progress report 625 includes information characterizing the applications that request dynamic web content that have recently been reviewed. Progress report 625 can identify those applications by name or other identifier. In some implementations, the applications that have recently been reviewed can be listed in progress report 625 in reverse order according to the time when review was completed.

Progress report 630 includes information characterizing the applications that request dynamic web content that have been found to be deficient. Progress report 630 can identify the deficient applications by name or other identifier. In some implementations, deficient applications can be listed in progress report 625 along with a summary or other characterization of their deficiencies.

Progress report 635 includes information characterizing the clients that have been testing applications that request dynamic web content and that have had unscheduled testing interruptions. For example, progress report 635 can list clients that have locked-up during the testing of applications that request dynamic web content. Progress report 635 can identify the clients with problems by name or other identifier. In some implementations, the applications that were being tested when the problems surfaced can also be listed in progress report 625.

Although progress reports 605, 610, 615, 620, 625, 630, 635 are shown together in a single display of information 600, this is not necessarily the case. For example, progress reports 605, 610, 615, 620, 625, 630, 635 can be displayed in multiple windows and/or on multiple screens. Further, various features in progress reports 605, 610, 615, 620, 625, 630, 635 can themselves be interactive elements that can receive user input. For example, application identifiers and client identifiers can be interactive information that trigger, in response to user interaction, the presentation of additional information characterizing the respectively identified application or client.

FIG. 7 is a flowchart of a process 700 for the repeated testing of applications that request dynamic web content. Process 700 can be performed by a system of one or more data processing devices that perform operations in accordance with the logic of one or more sets of machine-readable instructions. The instructions can be tangibly embodied in hardware, in software, or in combinations thereof. For example, process 700 can be performed by server system 105 in system 100 (FIG. 1). Process 700 can be performed alone or in conjunction with other activities. For example, process 700 can be performed in conjunction with process 500 (FIG. 5).

The system performing process 700 pairs an application that requests dynamic web content with a client that is to perform a test on that application at 505 and identifies the application that requests dynamic web content to the paired client at 510.

The system performing process 700 also receives a confirmation of the start of testing of the paired application at 705. In some instances, the system can also receive confirmations of initial progress in this testing. However, the system performing process 700 identifies that progress in the testing is deficient at 710. For example, the system can determine that confirmations of progress have not been received, e.g., for a threshold period of time or that the confirmations of progress in testing of the application are being received too rarely, indicating that the rated of testing progress is too low.

The system performing process 700 takes corrective action that addresses the deficient testing progress at 715. For example, in some implementations, the system performing process 700 halts the testing of the application at its paired client automatically or in response to user interaction with an interactive graphical element such as widget 655 (FIG. 6). In some implementations, the system performing process 700 can reassign the application to another client. In some implementations, this other client can test the reassigned application using the same environment and the same testing routine. In other implementations, this other client can test the reassigned application using the same environment but with a different testing routine. In still other implementations, this other client can test the reassigned application using both a different environment and a different testing routine.

In still other implementations, the system performing process 700 addresses the deficient testing progress by halting a current testing protocol and restarting testing of the application at the same client. In effect, the pairing between the application and the client established at 505 is maintained in such implementations.

In any case, the system performing process 700 resumes testing of the client at 720, either with the application that is paired to the client at 505 or with a different application in response to reassignment of the application to another client.

[Note to inventors: The following boilerplate says the invention can be implemented in all manner of digital computer and circuit technology.]

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. For example, some portion of the testing of applications that request dynamic web content can be performed at a server and the remainder of the testing at an application testing client. For example, server system 105 can perform relatively simple tests, including tests that do not involve requests for dynamic web content and tests that check the content of an application, e.g., for viruses or other malicious content, trademarks, and/or copyright.

In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system for the repeated testing of a collection of applications that request dynamic web content, the system comprising:
a collection of application testing clients, wherein each of the application testing clients in the collection comprises one or more data processing devices and is programmed to test applications that request dynamic web content by executing assigned applications;
a server system comprising
one or more data storage devices storing information characterizing the collection of applications that request dynamic web content that are to be repeatedly tested,
one or more data processing devices programmed to:
repeatedly assign the applications in the collection to respective of the application testing clients for testing each of the applications and communications of each of the applications before and after distribution of the applications, and
in response to receipt of a confirmation from a particular application testing client in the collection of application testing clients that testing of a first application from the collection of applications is completed, transmit an identifier of a second application from the collection of applications to the particular application testing client,
a proxy programmed to disguise the Internet Protocol address of at least one of the application testing clients, and
one or more communications interfaces operable to exchange information with the application testing clients.

2. The system of claim 1, wherein:
each client is programmed to collect at least some of the content of one or more messages exchanged with the applications as a result of the execution;
the application testing clients are programmed to transmit the collected content to the server system; and
the server system is programmed to record the transmitted content in the one or more data storage devices.

3. The system of claim 2, wherein the collected content comprises URLs from which the dynamic web content was requested during the testing.

4. The system of claim 3, wherein the server system is programmed to compare the URLs from which the dynamic web content was requested with a list of problem URLs.

5. The system of claim 1, wherein:
the application testing clients are each programmed to collect statistics regarding the messages exchanged as a result of the execution and to transmit the collected statistics to the to the server system; and
the server system is programmed to record the transmitted statistics in the one or more data storage devices.

6. The system of claim 1, wherein the one or more data processing devices of the server system are programmed to assign the applications to the respective of the application testing clients according to test-dependent factors that characterize the particular test to be performed by the respective of the application testing clients.

7. The system of claim 6, wherein the one or more data processing devices of the server system are programmed to assign the applications to the respective of the application testing clients according to the testing routines used at the respective of the application testing clients.

8. The system of claim 6, wherein the one or more data processing devices of the server system are programmed to assign the applications to the respective of the application testing clients according to the testing environment used at the respective of the application testing clients.

9. (canceled)

10. The system of claim 1, further comprising a security barrier that separates server system from application testing clients.

11. The system of claim 1, wherein the server system is further programmed to interpret the collected content and to take remedial action in light of the interpretation of the collected content.

12-20. (canceled)

21. A method comprising:
storing, by one or more data storage devices, information characterizing a collection of applications that request dynamic web content that are to be repeatedly tested;
repeatedly assigning, by one of a plurality of data processing devices, the applications in the collection to a respective application testing client from a collection of application testing clients to test each of the applications and communications of each of each of the applications before and after distribution of the applications, wherein each of the application testing clients in the collection of application testing clients comprises one or more data processing devices and is programmed to test applications that request dynamic web content by executing assigned applications; and
in response to receipt of a confirmation from a particular application testing client in the collection of application testing clients that testing of a first application from the collection of applications is completed, transmitting an identifier of a second application from the collection of applications to the particular application testing client by exchanging, using one or more communications interfaces, information with the particular application testing client.

22. The method of claim 21, comprising:
disguising, by a proxy, the Internet Protocol address of at least one of the application testing clients.

23. One or more tangible computer storage media persistently storing one or more computer programs, the one or more programs comprising instructions that when executed by one or more data processing apparatus cause the one or more data processing apparatus to perform operations, the operations comprising:
storing, by one or more data storage devices, information characterizing a collection of applications that request dynamic web content that are to be repeatedly tested;
repeatedly assigning, by one of a plurality of data processing devices, the applications in the collection to a respective application testing client from a collection of application testing clients to test each of the applications and communications of each of each of the applications before and after distribution of the applications, wherein each of the application testing clients in the collection of application testing clients comprises one or more data processing devices and is programmed to test applications that request dynamic web content by executing assigned applications;
exchanging, using one or more communications interfaces, information with the particular application testing client; and
disguising, by a proxy, the Internet Protocol address of at least one of the application testing clients

24. The computer storage media of claim 23, comprising:
in response to receipt of a confirmation from a particular application testing client in the collection of application testing clients that testing of a first application from the collection of applications is completed, transmitting an identifier of a second application from the collection of applications to the particular application testing client.
